(19) United States
(12) Patent Application Publication
(10) Pub. No.: US 2025/0328266 A1
(43) Pub. Date: Oct. 23, 2025

(54) REDUCED POWER ADDRESSING CONFIGURATIONS

(71) Applicant: Micron Technology, Inc., Boise, ID (US)

(72) Inventor: Leon Zlotnik, Camino, CA (US)

(21) Appl. No.: 19/169,782

(22) Filed: Apr. 3, 2025

Related U.S. Application Data
(60) Provisional application No. 63/637,120, filed on Apr. 22, 2024.

(51) Int. Cl. G06F 3/06

(52) U.S. Cl. CPC G06F 3/0625; G06F 3/0634; G06F 3/0679

(57) ABSTRACT

Various reduced power addressing schemes in different configurations are monitored to assess the toggling characteristics of these schemes. The identified toggling characteristics, in relation to different configurations, are then analyzed in consideration of the associated costs of the reduced power addressing schemes. Among these configurations, the one found to optimize the balance between benefits and costs is selected for implementation as part of the reduced power addressing scheme.

### PRIORITY INFORMATION

This application claims the benefit of U.S. Provisional Application No. 63/637,120, filed on Apr. 22, 2024, the contents of which are incorporated herein by reference.

### TECHNICAL FIELD

Embodiments of the disclosure relate generally to electronic systems, and more specifically to reduced power addressing configurations.

### BACKGROUND

Various types of electronic devices such as logic circuits may store and process data. A logic circuit is an electronic circuit that processes digital signals or binary information, which can take on two possible values (usually represented as 0 and 1). The logic circuit can use logic gates to manipulate and transform the signals or binary information. Digital logic circuits can be used in a wide range of electronic devices including, for example, computers, calculators, digital clocks, and many other electronic devices that employ digital processing. Digital logic circuits can be designed to perform specific logical operations on digital inputs to generate digital outputs, and, in some instances, can be combined to form more complex circuits to perform more complex operations.

### BRIEF DESCRIPTION OF THE DRAWINGS

The present disclosure will be understood more fully from the detailed description given below and from the accompanying drawings of various embodiments of the disclosure.

FIG. 1 illustrates an example of a portion of a computing system that operates according to various reduced power addressing configurations in accordance with some embodiments of the present disclosure.

FIG. 2 schematically illustrates a monitor component configured to determine particular characteristics of address bits input to and output from an address encoder in accordance with various embodiments of the present disclosure.

FIG. 3 illustrates another example of a portion of a computing system that operates according to various reduced power addressing configurations in accordance with various embodiments of the present disclosure.

FIG. 4 illustrates another example of a portion of a computing system configured to perform reduced power addressing in accordance with various embodiments of the present disclosure.

FIG. 5 is a flow diagram corresponding to a method for reduced power addressing configurations in accordance with various embodiments of the present disclosure.

### DETAILED DESCRIPTION

Aspects of the present disclosure are directed to reduced power addressing configurations within electronic systems. Various components within an electronic system, such as a System-on-Chip (SoC), can be accessed via respective address buses. Such components can include memory devices (e.g., arrays), interface connectors having ports, buses etc. that have addresses that can be accessed via access requests originated from different entities (e.g., host processors). In some examples, these addresses having successive addresses (e.g., consecutive physical addresses) can be or need to be sequentially accessed as opposed to those addresses that are not necessarily sequentially accessed despite having successive addresses. The latter access scheme is known as “random access”, in which addresses can be independently accessed without the need to traverse through all the addresses sequentially from one end to the other end (e.g., from the beginning to the end or vice versa).

In a sequential access scheme, an address signal can be toggled to switch from one set of address bits (to access one portion of the memory) to the other set of address bits (to access a subsequent portion of the memory). In this approach, a quantity of toggles occurred in accessing the memory can often be based on a number of particular data values to be switched (e.g., “0” to “1” or “1” to “0”) between two sets of address bits, and each toggle can incur a power consumption. Therefore, the increased quantity of toggles can undesirably increase the power consumed in accessing the memory cells and it is desired to reduce the power consumption associated with sequentially accessing any addresses within the computing system.

As described in more detail herein, aspects of the present disclosure provide capability of encoding address bits to have a reduced Hamming distance code format as well as being capable of leveraging the benefit and cost of encoding the address bits to a reduced Hamming distance code format. As used herein, the term “reduced Hamming distance binary code” refers to binary code having a reduced Hamming distance between two consecutive values. Although embodiments are not so limited, the reduced Hamming distance binary code can be reflected binary code (RBC) code (alternative referred to as “Gray code”), Johnson ring (cyclic) code, etc., as compared to a binary code that is not tailored to reduce a Hamming distance (alternatively referred to as “non-reduced Hamming distance binary code” or simply referred to as “binary code format”). In some embodiments, the reduced Hamming distance binary code can be unit-distance binary code, such as RBC code, in which two successive binary values differ in a single bit position.

A reduced Hamming distance code format is designed in a manner that, when switching from one set of address bits to another to sequentially access two addresses, only a small number of bits change, often just one. This deliberate reduction in bit changes during the transition helps significantly reduce power consumption, as compared to methods that do not use this specific encoding. This means that the power consumed in changing addresses is reduced because the switch from one set of address bits to another involves toggling only a controlled number of bits, typically just a single bit. Further, the device aging and deterioration can be mitigated when the aging mechanism of hot carrier injection (HCl) is alleviated by reducing the number of and/or frequency of toggling. Nevertheless, encoding address bits to a reduced Hamming distance code format to access memory locations may not be justified in some instances, as the encoding process involves additional circuitry. This circuitry, utilized for the encoding process (e.g., flipping bits of the incoming address bits) can be costly and/or power-inefficient.

Therefore, the embodiments of the present disclosure provide a monitoring scheme for address bits in different formats, allowing the leveraging of benefits and costs associated with accessing target components using address bits with reduced Hamming distance and binary code formats. For example, the monitoring scheme can provide information associated with the reduced “toggles” when accessing target components using address bits in a reduced Hamming distance format as compared to using address bits in a non-reduced Hamming distance format (e.g., a binary code format). The embodiments of the present disclosure further provide a decision scheme, which can configure address encoders (that encode incoming address bits to a reduced Hamming distance format) to encode (or not encode) the address bits in a manner that can increase the benefit of the encoding scheme, as described herein and determined by the decision scheme based on the information provided by the monitoring scheme. In various embodiments, the monitoring of the address traffic can be used to determine which portion (e.g., how many) of the address bits are to be encoded in order to achieve a desired among of reduced bit toggles (e.g., “toggle savings”).

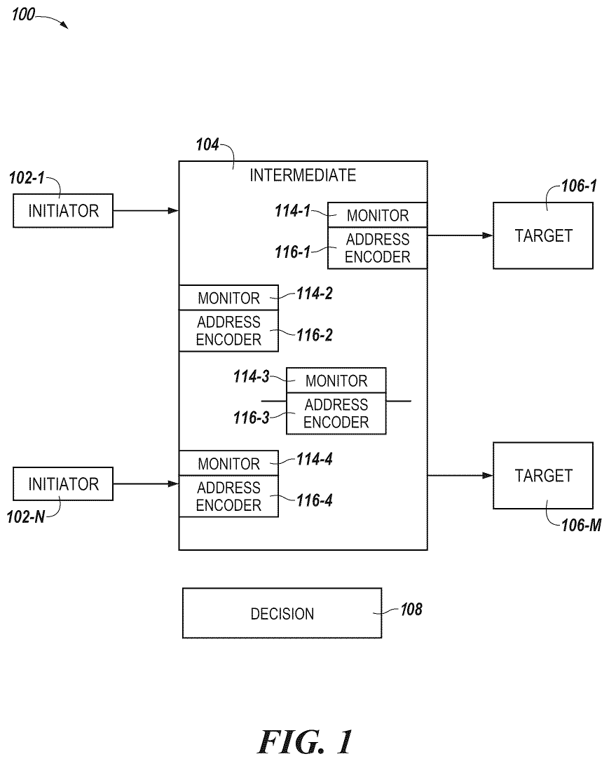

FIG. 1 illustrates an example of a portion of a computing system 100 that operates according to various reduced power addressing configurations in accordance with some embodiments of the present disclosure. While the computing system 100 can be considered as an apparatus, embodiments are not so limited. For example, the initiator 102, the intermediate component 104, the target component 106, the decision component 108, the monitor component 114, and the address encoder 116 can each separately be considered as an apparatus.

The computing system 100 can be a computing device such as a desktop computer, laptop computer, server, network server, mobile computing device, a vehicle (e.g., airplane, drone, train, automobile, or other conveyance), Internet of Things (IoT) enabled device, embedded computer (e.g., one included in a vehicle, industrial equipment, or a networked commercial device), system-on-chip (SoC), chipsets (e.g., a collection of integrated circuits), tiles, Field-Programmable Gate Arrays (FPGA) structures (e.g., segmented FPGA structures), or such computing device that includes memory and a processing device. As used herein, the term “mobile computing device” generally refers to a handheld computing device that has a slate or phablet form factor. In general, a slate form factor can include a display screen that is between approximately 3 inches and 5.2 inches (measured diagonally), while a phablet form factor can include a display screen that is between approximately 5.2 inches and 7 inches (measured diagonally). Examples of “mobile computing devices” are not so limited, however, and in some embodiments, a “mobile computing device” can refer to an IoT device, among other types of edge computing devices.

As illustrated in FIG. 1, the computing system 100 includes initiator components 102-1, . . . , 102-N. The initiator components 102 (alternatively referred to as initiators) are entities from which an access request are provided. For example, the initiator components 102 can generate and issue an access request to access (e.g., to write data to or read data from) memory locations of a particular target component 106 (e.g., one of target components 106-1, . . . , 106-M). Although embodiments are not so limited, the initiator components 102 can be processing resources including various processing units, such as a central processor unit (CPU), direct memory access (DMA) processor, digital signal processor (DSP), etc.

The computing system 100 includes target components 106-1, . . . , 106-M (referred to generally as target components 106). The target components 106 are entities to which access requests (e.g., generated at the initiator component 102) can be routed. Access requests (when executed at and/or in association with the target component 106) can include addresses (e.g., of target components 106) to be accessed and can be directed to addresses (e.g., corresponding to memory locations) of the target components 106. As an example, the target component 106 can be an entity with addresses to be accessed via the access requests (e.g., from the initiators 102). As described further herein, the addresses of access requests can be encoded and/or decoded to be in different formats.

In some embodiments, the target component 106 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

In some embodiments, the target component 106 can be a physical host interface (e.g., interface connector) that has addresses to be accessed via the access requests. For example, ports (e.g., initiator port of another interface, loopback port of the same fabric, input/output (I/O) ports, etc.) of the target components 106 can have addresses that can be accessed via access requests provided from initiator components 102. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), Small Computer System Interface (SCSI), a double data rate (DDR) memory bus, a dual in-line memory module (DIMM) interface (e.g., DIMM socket interface that supports Double Data Rate (DDR)), Open NAND Flash Interface (ONFI), Double Data Rate (DDR), Low Power Double Data Rate (LPDDR), or any other physical host interface that transfers data according to various communication protocols, such as an NVM Express (NVMe) interface, universal asynchronous receiver/transmitter (UART) protocols, or any other protocols.

Further, in some embodiments, target components 106 can be addresses of interconnect, fabric (e.g., system-on-chip fabric), crossbar, network on a chip, intellectual property (IP) cores (e.g., one or more blocks of data and/or logic that form constituent components of an application-specific integrated circuit or field-programmable gate array), partitions, (e.g., digital or analog) domains, components, modules, structures, etc. that can be sequentially addressed.

Some target components 106 may be compatible with access via address bits having a reduced Hamming distance code format, while some target components 106 may not be compatible with such format. For example, those target components 106 that can be sequentially addressed may be compatible with access via address bits having a reduced Hamming distance code format, while those target components 106 that are not sequentially addressable (e.g., the target components 106 that are randomly addressed) may not be compatible with such format.

As illustrated in FIG. 1, the computing system 100 includes an intermediate component 104, through which access requests generated at the initiator components 102 can be routed. The intermediate component 104 can include hardware circuitry to perform the operations described herein, such as selectively routing access requests received from one or more initiator components 102 to respective target components 106, etc. For example, the intermediate component 104 can include special purpose circuitry in the form of an ASIC, FPGA, state machine, and/or other logic circuitry.

The intermediate component 104 can be coupled between the initiator components 102 and target components 106. As used herein, “coupled to”, “coupled with”, or “coupled between” generally refers to a connection between components, which can be an indirect communicative connection or direct communicative connection (e.g., without intervening components), whether wired or wireless, including connections such as electrical, optical, magnetic, and the like. Although the intermediate component 104 is illustrated in FIG. 1 as being distinctive from initiator and target components 102 and 106, the intermediate component 104 can be part of one or more initiator components 102-1, . . . , 102-N or one or more target components 106, or any combination thereof.

The intermediate component 104 can be “interconnects” (e.g., Network-on-Chip (NOC), fabric interconnect, ring interconnect, bus interconnect, etc.), one or more buses, or transmission lines, or any combination thereof, that connects multiple/different entities (such as parts/components/modules, etc.) and serves as data paths between the entities to ensure that access requests can reach target components 106 (variously located within the computing system 100). In various embodiments, the intermediate component 104 includes one or more address encoders (e.g., 116-1, 116-2, 116-3, and 116-4, referred to generally as address encoders 116) that can respectively encode address bits of access requests and to ensure that access requests can be executed in the desired formats (e.g., reduced Hamming distance code format or binary code format, or any combination thereof) at those target components 106. As used herein, the term “encoding” refers to converting a format of address bits to a reduced Hamming distance binary code format (e.g., from a binary code format). Although not illustrated in FIG. 1, the intermediate component 104 can also include an address decoder that can decode address bits of access requests. As used herein, the term “decoding” refers to converting a format of address bits to a binary code format (e.g., from a reduced Hamming distance binary code format).

The address encoders 116 can include hardware circuitry to perform the operations described herein, such as converting one or more address bits having one format to another. For example, the address encoders can include logic gates (e.g., XOR, AND, OR, or NOT gates, or any combination thereof) configured to flip one or more bits of the incoming address bits. In some embodiments, at least a portion of initiator components 102 can also include an address encoder that provides substantially the same functionality as the address encoder 116; thereby, eliminating a need for those access requests provided from the initiator component 102 to be encoded at the intermediate component 104.

A reduced Hamming distance code format is designed in a manner that, when switching from one set of address bits to another to sequentially access two addresses, only a small number of bits change, often just one. Accordingly, the encoded sets of address bits, when toggled to be switched from one set of address bits to another set of address bits, reduces a quantity of toggles, which can significantly reduce power consumption compared to methods that do not use this specific encoding. In essence, this means that the power consumed in changing addresses is reduced because the switch from one set of address bits to another involves toggling only a controlled number of bits, typically just a single bit.

The address encoders 116 can encode incoming address bits in various manners as instructed by a configuration. For example, the address encoder 116 can convert address bits [11:06] of the set of incoming address bits to a reduced Hamming distance binary code format while in one configuration, while converting address bits [08:06] of the set of incoming address bits to a reduced Hamming distance binary code format while in a different configuration. As described herein, the address encoders 116 can be configured by the decision component 108 to operate in a particular configuration. The address encoders 116 can be configured in various manners. For example, the address encoders 116 can be provided a specific value or setting, determining their operational parameters. Alternatively, the address encoders 116 can include configuration registers that are configured to store one or more configurations, although embodiments are not so limited.

The intermediate component 104 can provide various mechanisms that allows one or more sets of address bits to be transferred to target components 106 (e.g., which may not be compatible with access via address bits having a reduced Hamming distance code format) in a binary code format as opposed to a reduced Hamming distance code format. For example, access requests encoded at least at one of the address encoders 116 can be decoded at the address decoder (not illustrated in FIG. 1) prior to being transferred to the target components 106. Accordingly, address bits of the access requests decoded at the address decoder and received at the target component 106 can be in a binary code format (as opposed to a reduced Hamming distance code format) and executed as a binary code format at the target component 106. Further, for example, access requests can be directly transferred to the target components 106 without being encoded and/or decoded (so that the binary code format can remain as originally generated).

In the example illustrated in FIG. 1, the intermediate component 104 further includes monitor components 114-1, 114-2, 114-3, 114-4 (referred to generally as monitors 114) corresponding to respective address encoders 116. Although the intermediate component 104 is illustrated as having four monitor components 114 and address encoders 116, embodiments are not limited to a particular quantity of monitor components 114 and/or address encoders 116 the intermediate component 104 can include. The monitor component 114 can include hardware circuitry to perform the operations described herein. For example, the intermediate component 104 can include special purpose circuitry in the form of an ASIC, FPGA, state machine, and/or other logic circuitry. As illustrated in FIG. 1, the monitor components 114 can be embedded into the intermediate component 104.

The monitor components 114 can monitor particular characteristics (e.g., toggling characteristics) of address bits being input to and output from the respective address encoders 116. As used herein, the term “monitoring” of address encoders of the similar type can refer to determining toggling characteristics associated with the address encoders. For example, the monitor component 114 can determine how many “toggles” would be needed to access target components 106 with address bits having a reduced Hamming distance binary code format as well as with address bits having a binary code format (e.g., non-reduced Hamming distance binary code format). The monitor component 114 can compare these toggles associated with a reduced Hamming distance binary code format and a binary code format and can report this information associated with the comparison to a decision component 108. Although embodiments are not so limited, each monitor component 114 illustrated in FIG. 1 can operate independently of the other monitor components 114 such that data including information associated with toggling characteristics and/or comparison between the toggles can be independently monitored (e.g., collected) and reported to the decision component 108.

In some embodiments, the data can be collected from multiple monitor components 114 (e.g., to the decision component 108) in parallel (alternatively referred to as “substantially simultaneously), which allows simultaneous monitoring of multiple reduced Hamming distance binary code combinations. As used herein, the term “substantially” means that the characteristic need not be absolute, but is close enough so as to achieve the advantages of the characteristic. For example, “substantially simultaneously” is not limited to operations that are performed absolutely simultaneously and can include timings that are intended to be simultaneously but due to manufacturing limitations may not be precisely simultaneously. Further, in some embodiments, the address encoders 116 can be monitored by the respective monitor components 114 in a sequential manner (e.g., such that the data can be collected from multiple monitor components 114 in a sequential manner).

The data collected from the monitor components 114 can be used by the decision component 108 to leverage benefits and costs of accessing (e.g., memory locations of) target components 106 using address bits encoded in different manners (e.g., configurations). For example, the toggling characteristic (e.g., the reduced toggling amount) associated with each configuration can be evaluated in consideration of the associated costs, such as area, power consumption, etc. associated with implementing additional address encoders (e.g., logic gates) required for some configurations (e.g., in the event that more bits need to be flipped in some configurations). Among these configurations, the one found to optimize the balance between toggling characteristics and the associated costs can be selected by the decision component 108. The decision component 108 can provide signaling to cause address encoders 116 to encode incoming address bits according to the selected configuration (e.g., the designated portion of the address bits).

In some embodiments, the decision component 108 can configure one or more address encoders 116 to encode incoming sets of address bits in a particular manner. This process involves providing a particular configuration from the decision component 108 to the address encoders 116, causing the address encoders 116 to encode the incoming address bits according to the particular configuration. This provided configuration can be one of the configurations determined to be more advantageous (e.g., in terms of benefits versus costs associated with the encoding process) than operating the address encoders 116 in different configurations.

In some embodiments, the decision component 108 can disable one or more address encoders 116, ensuring that none of bits from one or more sets of address bits received by the address encoders 116 are encoded (e.g., converted to a reduced Hamming distance code format). This decision can be made by the decision component 108 when it determines that encoding address bits according to any one of the various configurations is not advantageous, considering the benefits versus costs associated with the encoding according to the configurations.

Although the decision component 108 is illustrated as being separate from the monitor component 114, the decision component 108 can be part of the monitor component 114 such that the monitor component 114 provides the functionalities offered by the decision component 108. For example, the monitor component 114 having the decision component 108 can be further capable of configuring the respective address encoder 116 to encode the incoming address bits (e.g., by converting at least a portion of the address bits to a reduced Hamming distance binary code format) in a particular manner determined as a result of the leverage.

Further, although the decision component 108 is illustrated as being separate from the initiator components 102, the decision component 108 can correspond to the initiator component 102 such that the initiator component 102 can eventually provide the functionalities provided by the decision component 108, such as converting at least a portion of the address bits to a reduced Hamming distance binary code format.

In some embodiments, the monitor components 114 may be implemented as a model, for example, using languages such as Verilog, SystemC, etc. In this example, data is collected (e.g., from the monitor components 114) and analyzed, and address encoders 116 can be configured in a manner determined as a result of the analysis of the data collected from the monitor components 114. This analysis and the determination of the manner in which the address encoders 116 are configured to operate can be performed during the initial design phase (e.g., the design phase of the computing device 100), which can be independent of additional hardware or firmware implementations. This approach offers cost-effective solutions, eliminating the necessity for additional hardware/firmware, such as logic gates.

In some embodiments, the monitor components 114 can be implemented in forms of hardware, firmware, or any combination thereof. In this example (e.g., particularly when the monitor components 114 are implemented in forms of hardware), data is collected from the monitor components 114. In this example, those monitor component 114 that are not actively monitoring or need not actively monitor respective address encoders 116 may be put into a reduced power state (e.g., inactive, power sleep, or power-off state, etc.).

In some embodiments, the address encoders 116 can be static once configured. For example, once the address encoders 116 are initially configured, the configurations of the address encoders 116 may remain the same throughout the operation of the computing system 100.

In some embodiments, the address encoders 116 can be dynamically configured (e.g., at least more flexibly configurable than the static configuration). In this dynamic configuration, the address encoders 116 can be configured differently subsequent to the initial configuration. The address encoders 116, in some examples, may be limited to be configured differently, especially when doing so would interrupt access of the target components 106. For example, if the data is already allocated in one or more memory locations of the target components 106, making changes to the encoding configuration midway can result in the data no longer being available at the same address. Hence, dynamic configuration can be carried out in a manner that avoids disruptions in the accessibility of data previously allocated within the target components 106.

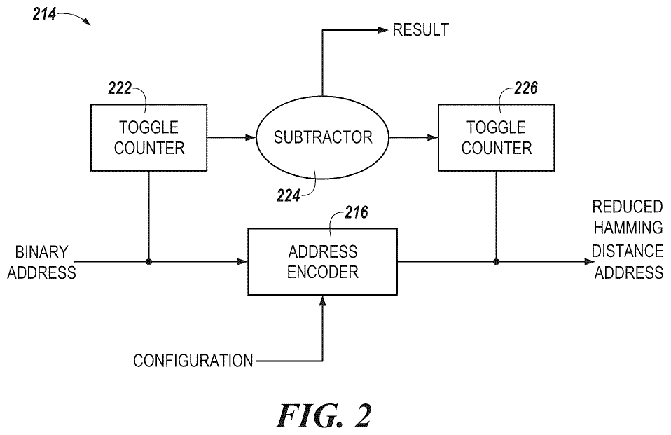

FIG. 2 schematically illustrates a monitor component 214 configured to determine particular characteristics of address bits input to and output from an address encoder 216 in accordance with various embodiments of the present disclosure. The monitor component 214 and address encoder 216 can be respectively analogous to the monitor component 114 and address encoder 116 described in connection with FIG. 1.

As illustrated in FIG. 2, the monitor component 214 can include toggle counters 222 and 226 respectively to an input and an output of the address encoder 216. For example, the toggle counter 222 determines an amount of “toggles” that would be needed to access (e.g., memory locations of) target components (e.g., one or more target components 106 illustrated in FIG. 1) with address bits having a non-reduced Hamming distance binary code format, while the toggle counter 226 determines an amount of “toggles” that would be needed to access target components (e.g., one or more target components 106 illustrated in FIG. 1) with address bits having the converted format (e.g., as a result of the conversion performed at the address encoder 216), such as a reduced Hamming distance binary code format. The monitor component 214 may also include a subtractor (e.g., the subtractor 224 illustrated in FIG. 2) that determines a difference in amounts of “toggles” respectively determined at the toggle counters 222 and 226.

The address encoder 216 can encode incoming address bits (e.g., sets of address bits respectively to access memory locations) in a manner in which the address encoder is configured to do so. In a number of embodiments, the address encoder 216 can be configured differently from time to time (e.g., periodically) to encode incoming address bits in different manners. For example, the address encoder 116 can be initially configured to convert address bits [11:06] of each set of address bits having a non-reduced Hamming distance binary code format to a reduced Hamming distance binary code format, while the address encoder 116 can be subsequently configured to convert address bits [08:06] of each set of address bits having a non-reduced Hamming distance binary code format to a reduced Hamming distance binary code format.

The address encoder 216 that operates in different configurations as described above allows a decision component (e.g., the decision component 108 illustrated in FIG. 1) to collect data (e.g., from monitor components, such as the monitor component 214) corresponding to the different configurations. The data corresponding to the different configurations can be further utilized by the decision component 108 to leverage benefits and costs of operating the address encoder 216 according to the different configurations.

As described herein, sets of address requests can be respectively encoded at the address encoder 216 such that a format of each set of address bit can be converted from one (e.g., binary code format) to another (e.g., reduced Hamming distance code format). In an example scenario, sets of address bits that are to be used for sequentially accessing 8 different address of one or more target components (e.g., the target components 106 illustrated in FIG. 1) can each have at least three bits in a reduced Hamming distance code format (e.g., an RBC format) or a natural binary code format as follows:

TABLE 1

| | | Natural |
|---|---|---|
| | | Binary |
| | RBC | Code |
| 1st access | 000 | 000 |
| 2nd access | 001 | 001 |
| 3rd access | 011 | 010 |
| 4th access | 010 | 011 |
| 5th access | 110 | 100 |
| 6th access | 111 | 101 |
| 7th access | 101 | 110 |
| 8th access | 100 | 111 |

As illustrated in Table 1, these eight sequential accesses using address bits having a natural binary code format involves eight toggles on a bit position 0 (e.g., the least significant bit (LSB)) (e.g., to program a bit position 0 to “0” for 1^{st} access and switching from “0” to “1” or “1” to “0” over 7 subsequent accesses), four toggles on a bit position 1 (e.g., to program a bit position 1 to “0” for 1^{st} access and switching from “0” to “1” between 2^{nd} and 3^{rd} accesses and 6^{th} and 7^{th} accesses), and two toggles on a bit position 2 (e.g., the most significant bit (MSB)) (e.g., to program a bit position 2 to “0” for 1^{st} access and switching from “0” to “1” between 4^{th} and 5^{th} accesses). Alternatively, the same eight sequential accesses but using address bits having an RBC format total eight toggles since switching between any two accesses involves only a single toggle. Therefore, power consumption associated with address toggling using an RBC format can be reduced by 6/14 as compared to that using a natural binary code format. Accordingly, these (e.g., at least) 8 sets of address bits having a natural binary code format can be input to the address encoder 216 can be converted to those 8 sets of address bits having a reduced Hamming distance binary code format, such as an RBC format for the sequential accesses to addresses of the target components 106.

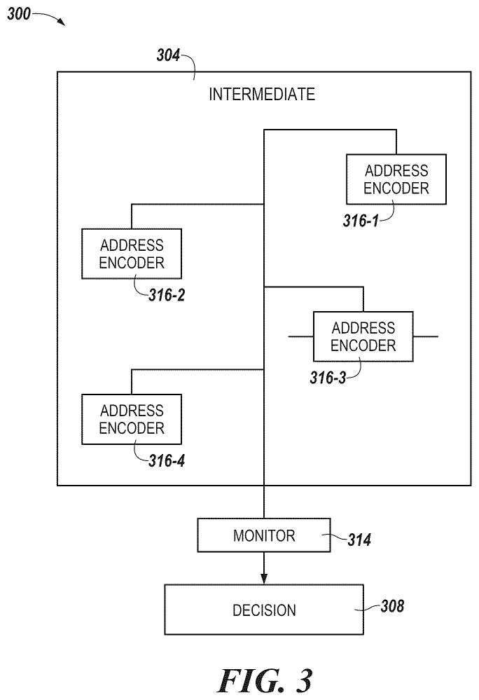

FIG. 3 illustrates another example of a portion of a computing system 300 that operates according to various reduced power addressing configurations in accordance with various embodiments of the present disclosure. The intermediate component 304, decision component 308, monitor component 314, and address encoders 316 can be respectively analogous to the intermediate component 104, decision component 108, monitor component 114, and address encoders 116 described in connection with FIG. 1. Although four address encoders are illustrated in FIG. 3, embodiments are not limited to a particular quantity of address encoders the intermediate component 304 can include. In some embodiments, the decision component 308 can be part of and/or merged into an initiator component (e.g., the initiator component 102 illustrated in FIG. 1). Further, in some embodiments, the decision component 308 can provide its decision regarding the format conversion to the initiator components 102 to control addressing scheme of the initiator components 102.

The computing system 300 illustrated in FIG. 3 is generally analogous to the computing system 100 illustrated in FIG. 1 except that those toggling characteristics of the encoding process performed at the address encoders 316 are monitored by the “shared” monitor component 314 (e.g., as opposed to having multiple monitor components separately and respectively for address encoders as illustrated in FIG. 1). Therefore, data corresponding to the toggling characteristics of the address encoders 316-1, . . . , 316-4 can be collectively collected at the shared monitor component 314 and can be further reported to the decision component 308. Although embodiments are not so limited, address bits being input respectively to the address encoders 316 may be of same or similar address patterns and/or formats, which allows the address bits received and encoded by different address encoders 316 to be monitored by the shared monitor component 314. In some embodiments, the monitor component 314 can monitor the address encoders 316 in a periodic manner. The shared monitor 314 that can collectively monitor multiple address encoders 116 can provide benefits, such as eliminating a need for having multiple monitor components, which can be costly especially when the monitor components are implemented in forms of hardware.

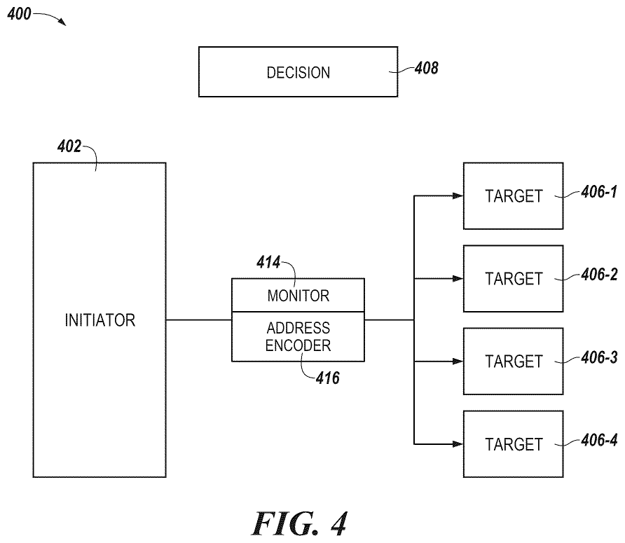

FIG. 4 illustrates another example of a portion of a computing system 400 configured to perform reduced power addressing in accordance with various embodiments of the present disclosure. The monitor component 414, address encoder 416, and decision component 408 can be respectively analogous to the monitor component 114, address encoders 116, and decision component 108 described in connection with FIG. 1.

Although embodiments are not so limited, the initiator component 102 can be a memory controller that can control performance of a memory operation for an access request (e.g., received from a host, which can be another initiator component 102). The memory operation can be a memory operation to read data (in response to a read request from the host) from or an operation to write data (in response to a write request from the host) to one or more target components 406.

The computing system 400 illustrated in FIG. 4 is generally analogous to the computing system 100, 300 illustrated in FIGS. 1 and 3 except that access requests to be transferred to multiple target components 406 are managed (e.g., encoded) at the shared address encoder 416, which is monitored by the monitor component 414. In this example, target components 406 (e.g., memories, addressable structured, etc.) may be accessible using the same set of address bits; thereby eliminating the need for separate address encoders for target components 406. This eliminates redundancy and spares space on the computing system 400 that would have been occupied by the separate address encoders/monitor components.

In some embodiments, the monitor component 414, address encoder 416, and target components 406 can be part of a memory wrapper. In this example, the monitor component 414 can be implemented as a behavioral model (introducing no hardware circuitry), while the address encoder 416 can be implemented in forms of hardware when enabled. Further, in some embodiments, data (e.g., testbench data) is collected at the decision component 408 from all the monitors (e.g., the monitor component 414) deployed across the computing system 400 throughout the development stage, particularly during regression tests.

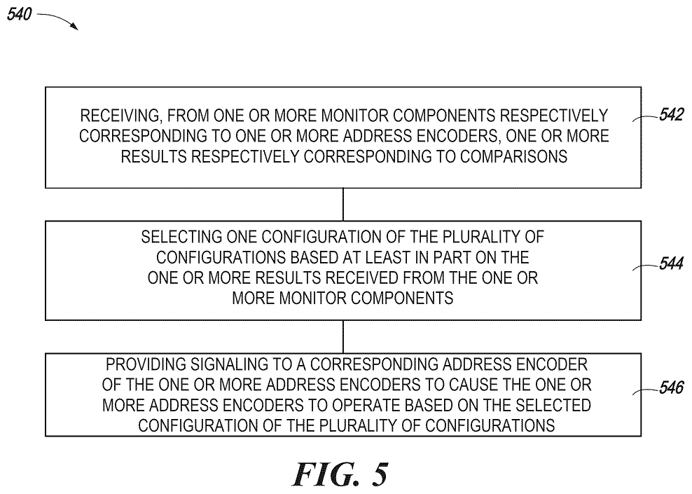

FIG. 5 is a flow diagram corresponding to a method 540 for reduced power addressing configurations in accordance with some embodiments of the present disclosure. The method 540 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 540 is performed by the decision component 108, 308, 408 and/or the monitor components 114, 214, 314, 414 of FIGS. 1-4. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 542, one or more results respectively corresponding to comparisons can be received (e.g., from one or more monitor components 114, 214, 314, 414 illustrated in FIGS. 1-4) respectively corresponding to one or more address encoders (e.g., the address encoders 116, 216, 316, 416 illustrated in FIGS. 1-4). Each comparison can correspond to a respective one of a plurality of configurations and is between a respective first number of toggles and a respective second number of toggles. In this example, the respective first number of toggles can be associated with accessing a respective memory location (e.g., of a target component 106, 406 illustrated in FIGS. 1 and 3-4) using a respective plurality of sets of address bits having a first format. Further, the respective second number of toggles can be associated with accessing the respective memory location using the respective plurality of sets of address bits with a first portion of the respective plurality of sets of address bits having a second format. The second format can correspond to a reduced Hamming distance binary code format that involves a reduced number of toggles in accessing the respective memory location than using the first format (e.g., a non-reduced Hamming distance code format, such as a binary code format). In some embodiments, the results can be collected (e.g., from multiple monitor components) in parallel (e.g., substantially simultaneously) or in a sequential manner (e.g., such that the results can be collected from multiple monitor components one at a time).

At operation 544, one of the plurality of configurations can be selected based at least in part on the one or more results (e.g., received from the one or more monitor components). In this example, each configuration of the plurality of configurations can correspond to a respective set of bit positions of a respective plurality of sets of address bits to be received at a corresponding one of the one or more address encoders and to be converted to the second format. For example, in one configuration, address encoders can be configured to convert address bits [3:0] of the set of address bits, while the address encoders can be configured to convert address bits [8:6] of the set of address bits in another configuration, although embodiments are not so limited. Continuing with this example, the method 540 can further include providing signaling to the corresponding address encoder of the one or more address encoders to cause the corresponding address encoder of the one or more address encoders to operate by converting a respective set of bit positions of the respective plurality of sets of address bits corresponding to the selected configuration.

At operation 546, signaling can be provided to a corresponding address encoder of the one or more address encoders to cause the one or more address encoders to operate based on the selected configuration of the plurality of configurations. In some embodiments, the signaling can be provided during a power cycling event of a computing system (e.g., the computing system 100, 300, 400 illustrated in FIGS. 1 and 3-4). For example, the signaling can be provided during a booting, a reset (e.g., a soft reset), or the pre-initialization phase of the computing system.

In some embodiments, it is determined whether to selectively prevent the one or more address encoders from converting any portion of the respective plurality of sets of address bits to the second format. This selective prevention can be determined based at least in part on the one or more results (e.g., received from the one or more monitor components). For example, if it is determined that operating one address encoder in any one of the plurality configurations would not yield benefits (e.g., reduced toggles) outweighing the associated costs the address encoder can be disabled such that sets of address bits received at the address encoder are not encoded. Accordingly, if it is determined as such, signaling can be selectively provided to the one or more address encoders to selectively prevent the one or more address encoders from converting any portion of the respective plurality of sets of address bits to the second format.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method, comprising:
receiving one or more results respectively corresponding to comparisons, wherein each comparison corresponds to a respective one of a plurality of configurations and is between a respective first number of toggles and a respective second number of toggles, wherein:
the respective first number of toggles is associated with accessing a respective memory location using a respective plurality of sets of address bits having a first format; and
the respective second number of toggles is associated with accessing the respective memory location using the respective plurality of sets of address bits with a first portion of the respective plurality of sets of address bits having a second format, wherein the second format corresponds to a reduced Hamming distance binary code format that involves a reduced number of toggles in accessing the respective memory location than using the first format;
selecting one configuration of the plurality of configurations based at least in part on the one or more results; and
providing signaling to a corresponding address encoder of the one or more address encoders to cause the one or more address encoders to operate based on the selected configuration of the plurality of configurations.

2. The method of claim 1, wherein:
each configuration of the plurality of configurations corresponds to a respective set of bit positions of a respective plurality of sets of address bits to be converted to the second format at a respective one of the one or more address encoders; and
the method further comprises providing signaling to the corresponding address encoder of the one or more address encoders to cause the corresponding address encoder of the one or more address encoders to operate by converting a respective set of bit positions of the respective plurality of sets of address bits corresponding to the selected configuration.

3. The method of claim 1, further comprising:
determining whether to selectively prevent the one or more address encoders from converting any portion of the respective plurality of sets of address bits to the second format based at least in part on the one or more results; and
selectively providing signaling to the one or more address encoders to selectively prevent the one or more address encoders from converting any portion of the respective plurality of sets of address bits to the second format.

4. The method of claim 1, further comprising providing the signaling to the corresponding address encoder of the one or more address encoders during a power cycling event of a computing system including the corresponding address encoder.

5. The method of claim 1, further comprising receiving the one or more results sequentially.

6. The method of claim 1, further comprising receiving the one or more results from substantially simultaneously.

7. An apparatus, comprising:
a plurality of address encoders, at least one address encoder of the plurality of address encoders configured to:
receive a first plurality of sets of address bits each having a first format;
convert, in a first configuration, a first portion of each of the first plurality of sets of address bits to a second format, wherein the second format corresponds to a reduced Hamming distance binary code format that involves a reduced number of toggles in accessing one target component than using the first format;
receive a second plurality of sets of address bits each having the first format; and
convert, in a second configuration, a second portion of the second plurality of sets of address bits to the second format; and
a first monitor component configured to:
compare a first number of toggles associated with access using the first plurality of sets of address bits having the first format to a second number of toggles associated with accessing a respective target component using the first plurality of sets of address bits with the first portion of the first plurality of sets of address bits having the second format; and
compare a third number of toggles associated with access using the second plurality of sets of address bits having the first format to a fourth number of toggles associated with accessing the respective target component using the second plurality of sets of address bits with the second portion of the second plurality of sets of address bits having the second format.

8. The apparatus of claim 7, wherein the first monitor component is configured to provide, to a decision component:
a first difference between the first number of toggles and the second number of toggles determined; and
a second difference between the third number of toggles and the fourth number of toggles;
wherein the at least one address encoder is configured to operate based on the first configuration or the second configuration that is selected by the decision component based on a comparison between a first difference between the first and second number of toggles and a second difference between the third and fourth number of toggles.

9. The apparatus of claim 7, wherein:
the first portion of each set of the first plurality of sets of address bits corresponds to a first set of bit positions of each set of address bits; and
the second portion of each set of the second plurality of sets of address bits corresponds to a second set of bit positions of each set of address bits.

10. The apparatus of claim 7, wherein:
the first plurality of sets of address bits correspond to one or more access requests to access a first target component; and
the second plurality of sets of address bits correspond to one or more access request to access a second target component.

11. The apparatus of claim 7, wherein:
a remaining portion of each of the first plurality of sets of address bits is not converted to the second format, while the first portion of each of the first plurality of sets of address bits is converted to the second format; and
a remaining portion of each of the first plurality of sets of address bits is not converted to the second format, while the second portion of each of the first plurality of sets of address bits is converted to the second format.

12. An apparatus, comprising:
a first address encoder configured to:
receive a respective first plurality of sets of address bits having a first format; and
convert a respective portion of each set of the respective first plurality of sets of address bits to a second format, wherein the second format corresponds to a reduced Hamming distance binary code format that involves a reduced number of toggles in accessing one target component than using the first format; and
a first monitor component configured to determine a respective difference between:
a number of toggles associated with access using the respective first plurality of sets of address bits having the first format; and
a number of toggles associated with access using the respective first plurality of sets of address bits with the respective portion of each set of the respective first plurality of sets of address bits having the second format.

13. The apparatus of claim 12, further comprising a second address encoder, the second address encoder configured to:
receive a respective second plurality of sets of address bits having the first format; and
convert at least a respective portion of each set of the respective second plurality of sets of address bits to the second format.

14. The apparatus of claim 13, wherein the first monitor component is configured to determine a respective difference between:
a number of toggles associated with access using the respective second plurality of sets of address bits having the first format; and
a number of toggles associated with access using the respective second plurality of sets of address bits with the respective portion of each set of the respective second plurality of sets of address bits having the second format.

15. The apparatus of claim 13, further comprising a second monitor component, the second monitor component configured to determine a respective difference between:
a number of toggles associated with access using the respective second plurality of sets of address bits having the first format; and
a number of toggles associated with access using the respective second plurality of sets of address bits with the respective portion of each set of the respective second plurality of sets of address bits having the second format.

16. The apparatus of claim 15, wherein:
the apparatus further comprises a decision component configured to select one of a plurality of different configurations based at least in part on the respective difference associated with the first address encoder or the second address encoder, wherein the respective portion of each set of the first plurality of sets of address bits or the second plurality of sets of address bits converted to the second format at the first address encoder varies based on a respective configuration of the plurality of different configurations the first encoder operates with; and
provide signaling to the first address encoder or the second address encoder to cause the first address encoder or the second address encoder to operate according to the selected one of the plurality of different configurations.

17. The apparatus of claim 16, wherein:
the decision component is further configured to determine whether to selectively prevent the first address encoder or the second address encoder so as not to convert any portion of each set of the respective first plurality of sets of address bits or the second plurality of sets of address bits to the second format; and
in response to the determination, provide signaling to the first address encoder or the second address encoder to prevent the first address encoder or the second address encoder from converting any portion of each set of the respective first plurality of sets of address bits or the second plurality of sets of address bits to the second format.

18. The apparatus of claim 12, wherein the respective first plurality of sets of address bits respectively correspond to a plurality of addresses of a respective target component that are to be sequentially accessed via the first plurality of sets of address bits.

19. The apparatus of claim 18, wherein respective binary values of two sets of address bits of the first plurality of sets of address bits differ in a single bit position.

20. The apparatus of claim 12, wherein the reduced Hamming distance binary code format is a reflected binary code (RBC) format, a Johnson ring binary code format, or a unit-distance code format, or any combination thereof.
